(19) United States
(12) Patent Application Publication
(10) Pub. No.: US 2013/0173209 A1
(43) Pub. Date: Jul. 4, 2013

(54) ACCELERATION SIGNAL PROCESSING DEVICE

(71) Applicant: Selko Instruments Inc., Chiba (JP)

(72) Inventor: Sadashi SHIMODA, Chiba (JP)

(73) Assignee: SEIKO INSTRUMENTS INC., Chiba (JP)

(21) Appl. No.: 13/706,413

(22) Filed: Dec. 6, 2012

(30) Foreign Application Priority Data
Dec. 9, 2011 (JP) 2011-269924

(51) Int. Cl. G01P 15/00

(52) U.S. Cl. CPC G01P 15/00
USPC 702/141

(57) ABSTRACT

In an acceleration sensor, it has been difficult to realize a circuit which has no current consumption at all during OFF of a system and is capable of activating a sensor main body when applied with vibration. Provided is an acceleration switch having one terminal connected to one of a positive power supply or a negative power supply, and another terminal connected to an interrupt input terminal of a microcomputer.

### BACKGROUND OF THE INVENTION

1. Field of the Invention

The present invention relates to an acceleration signal processing device.

2. Description of the Related Art

Conventionally, there is used a pedometer designed to be worn on the user's waist or the like or to be carried in a portable bag for use so that walking of the user is detected by a sensor to count his/her steps. This type of pedometer is configured to indicate the number of steps on a display portion. The conventional pedometer updates display data (step value) on the display portion every time a walking signal from an acceleration sensor is detected (see, for example, Japanese Patent Application Laid-open No. Sho 57-48176).

Conventionally, there is another type of pedometer designed to be worn on the arm or the waist for use. For example, in an arm pedometer designed to be worn on the arm for use, in order to improve the accuracy of step count, some methods have been proposed, such as detecting an arm swing for counting based on two steps and detecting vertical motion of the body for counting based on one step (see Japanese Patent Application Laid-open No. 2007-307218).

In general, the user sees the display of the pedometer not very frequently during walking. In view of this, it has been proposed to turn off the display operation upon detection of the state where a cover of a case of the pedometer is closed or the state where the pedometer is worn on the clothing, so as to save power. It is necessary, however, to provide a switch for detecting the open/close of the cover of the case of the pedometer, a switch for detecting that the pedometer is worn on the clothing, or other such switches, resulting in an increase in dedicated hardware and an increase in cost, which makes downsizing difficult. In addition, control for detecting the state of the switch is needed, and hence the configuration is complicated.

All the above-mentioned counter measures have been proposed to aim at extending the battery life of the battery-driven pedometer. This is because an acceleration signal processing device used in the pedometer has large current consumption. The reasons are that it is necessary to drive a microcomputer all the time in order to be ready to detect vibration applied to an acceleration switch all the time and that the microcomputer needs to drive the sensor all the time and prepare to detect an output signal of the sensor. In those circumstances, it is impossible to extend the battery life of the pedometer.

In the conventional technology, however, in the case of the acceleration signal processing device of the pedometer using the acceleration sensor and the microcomputer in combination, it is necessary to supply power for driving the sensor all the time that detects vibration or acceleration and for operating the microcomputer. Particularly in the case where the acceleration signal processing device is incorporated in a device that cannot mount only a small-capacity battery, the following configuration needs to be considered to avoid wasting electric power of the battery. That is, when no vibration is detected, a system including the acceleration signal processing device is set to a standby state, and, upon the detection of vibration, the system is operated. Even the system configured as described above, however, has a battery life of only about 1 to 2 years because of current consumption during standby.

### SUMMARY OF THE INVENTION

The present invention has been made in view of the above-mentioned circumstances, and it is an object thereof to provide a technology for extending the battery life of a pedometer to about 5 years. Specifically, with the use of an acceleration switch of FIG. 2, when the pedometer is not vibrated at all or when only a vibration of less than a predetermined value is applied, a microcomputer and a sensor in an acceleration signal processing device of the pedometer are completely stopped.

In the acceleration signal processing device, when vibration of the predetermined value or more is applied to the acceleration switch, on the other hand, the microcomputer and the sensor are activated. In the above, the phrase “when vibration of the predetermined value or more is applied” specifically means vibration that occurs when the pedometer is worn on the body after wake up.

In order to solve the above-mentioned problems, according to an exemplary embodiment of the present invention, there is provided an acceleration signal processing device, including; power supply sections having power supply voltages; an acceleration switch including one electrode to be supplied with the power supply voltage from one of the power supply sections; a microcomputer connected to another electrode of the acceleration switch; and a sensor main body capable or bi-directionally exchanging signals to and from the microcomputer, the sensor main body being configured to be one of activated and stopped in response to a signal from the microcomputer, and being configured to, when activated, output acceleration information to the microcomputer.

Further, according to the exemplary embodiment of the present invention, the acceleration signal processing device further includes a load element including one terminal connected between the acceleration switch and the microcomputer and another terminal connected to another of the power supply sections.

Further, according to the exemplary embodiment of the present invention, the load element includes at least one of a resistor, a capacitor, and a transistor.

Further, according to the exemplary embodiment of the present invention, the acceleration switch includes: a mass body having a space inside; a beam for supporting the mass body; and a counter electrode positioned inside the space.

Further, according to the exemplary embodiment of the present invention, the acceleration switch is switched to ON when the mass body and the counter electrode are brought into contact with each other, and a gap between the mass body and the counter electrode is set so that the mass body and the counter electrode are brought into contact with each other when vibration energy of a predetermined value or more is applied to the acceleration switch.

Further, according to the exemplary embodiment of the present invention, the predetermined value is an acceleration value when a human starts an action.

By adopting the configuration described above, in the acceleration signal processing device for the acceleration switch, at least one of the microcomputer and the acceleration sensor is activated in response to the ON state of the acceleration switch, to thereby activate the microcomputer or the acceleration sensor that has stopped its function till then. In this manner, it is possible to realize a device capable of suppressing current consumption of the microcomputer or the acceleration sensor while its function is stopped and eliminating current consumption of the acceleration signal processing device for the acceleration switch.

Specifically, in the acceleration signal processing device for the acceleration switch, means for enabling the acceleration switch is provided by disposing one acceleration switch, and the resistor, the capacitor, an element formed of the resistor and the capacitor, or an active element such as a transistor between the positive power supply and the negative power supply.

According to the acceleration signal processing device of the present invention, it is possible to configure the system capable of significantly reducing a drive current of the acceleration signal processing device when vibration applied to the acceleration switch is smaller than a predetermined value.

### BRIEF DESCRIPTION OF THE DRAWINGS

In the accompanying drawings:

FIG. 1 is a schematic diagram illustrating an acceleration signal processing device according to an embodiment of the present invention;

FIG. 2 is a schematic horizontal cross-sectional view of a conventionally-known acceleration switch;

FIG. 3 is a schematic vertical cross-sectional view of the conventionally-known acceleration switch;

FIG. 4 is an explanatory diagram of the operation of the conventionally-known acceleration switch; and

FIG. 5 is a schematic horizontal cross-sectional view illustrating an embodiment of the conventionally-known acceleration switch.

### DETAILED DESCRIPTION OF THE PREFERRED EMBODIMENTS

### First Embodiment

An exemplary embodiment or the present invention is described below with reference to the accompanying drawings. First, the structure and operation of a first acceleration switch disclosed in a design document are described.

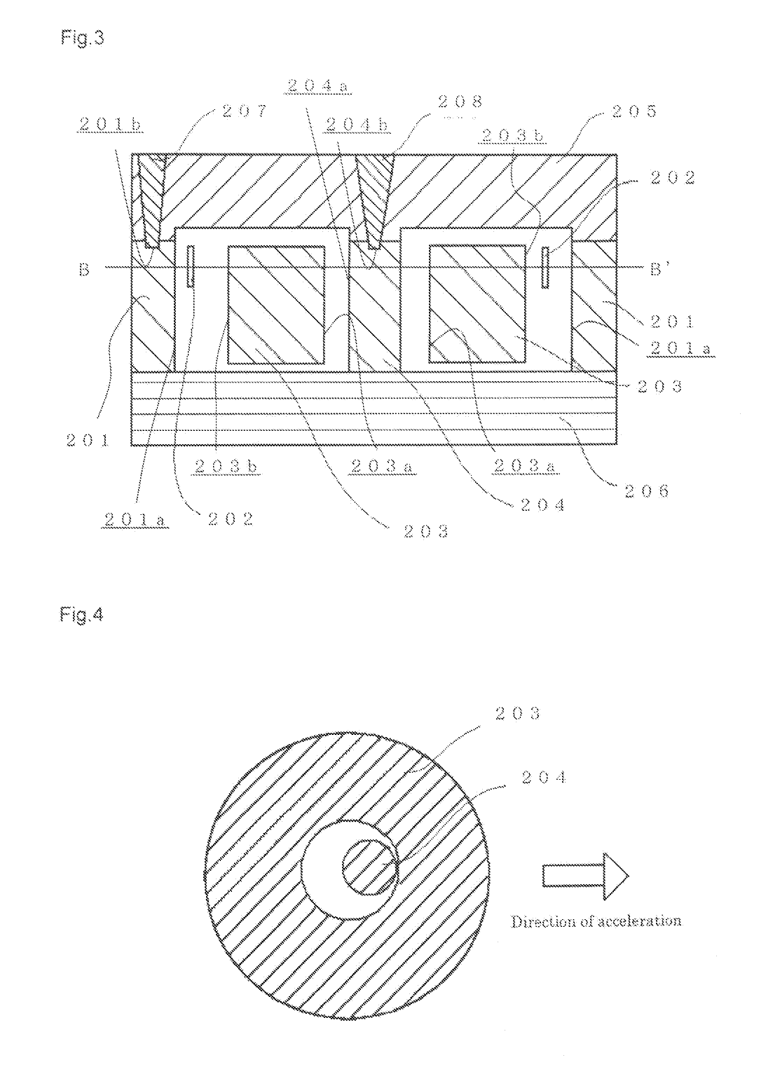

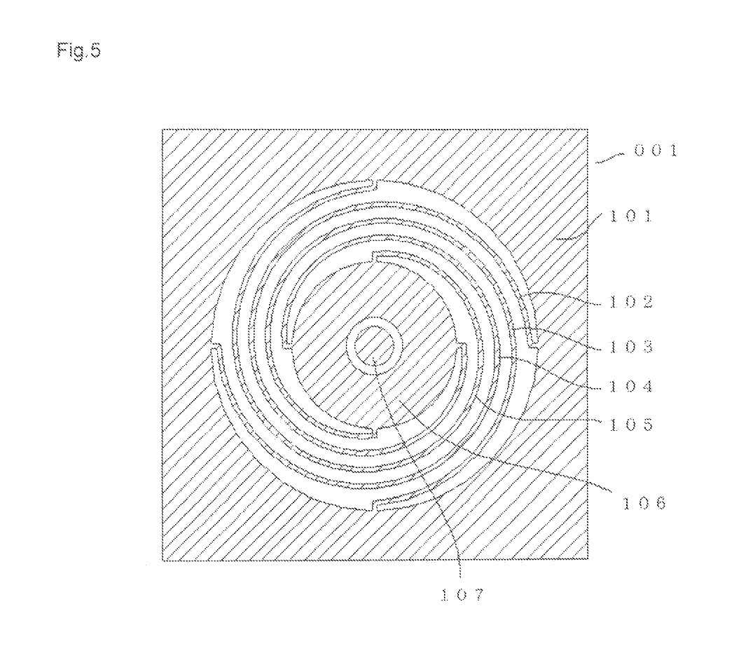

FIG. 5 is a top view illustrating the structure of an omnidirectional acceleration switch 001 as disclosed in Japanese Design No. 1310053, which includes a counter electrode in a space inside a mass body. Reference numeral 101 denotes a peripheral portion (outer frame) of the acceleration switch 001; 102 to 105, beams for supporting a weight 106; and 107, a counter electrode. However, the number of the beams is four and the structure is complicated, and hence the detailed description is given with reference to FIG. 2 illustrating a single beam instead of FIG. 5. Note that, the following description is not intended to exclude the four-beam configuration illustrated in FIG. 5 from the scope of the present invention, but is given to describe the embodiment of the present invention more simply.

FIG. 2 is a top view of a second acceleration switch 002 having a single beam as described above. In actual fact, however, a layer serving as a cap (first substrate 205 illustrated in FIG. 3) is present thereabove and a support layer (third substrate 206 illustrated in FIG. 3) is present thereunder. FIG. 3 is a cross-sectional view taken along the plane A-A′ illustrated in FIG. 2, and includes the layers omitted in FIG. 2. FIG. 2 corresponds to a diagram taken along the plane B-B′ of FIG. 3.

As illustrated in FIGS. 2 and 3, the acceleration switch 002 is formed by laminating, from above, the first substrate (cap layer) 205 using an insulating material such as glass, a second substrate 201 (also including 202, 203, and 204) using monocrystalline silicon or the like, and the third substrate (support layer) 206 using an insulating material such as glass. For example, low-resistivity silicon is used as the monocrystalline silicon of the second substrate in order to establish electrical conduction. Through electrodes 207 and 208 are formed by embedding metal such as gold in the first and second substrates 205 and 201, and serve as contacts for connecting the acceleration switch to the outside. The first substrate and the third substrate are bonded to the second substrate by a method such as anodic bonding.

In the following, the specific shape of the acceleration switch 002 according to the first embodiment of the present invention is described with reference to FIGS. 2 and 3.

First, the second substrate of the acceleration switch 002 includes a substrate peripheral portion 201, a beam 202, a mass body 203, and a counter electrode 204 in this order from outside to inside of FIG. 2.

The substrate peripheral portion 201 except for a bonding portion with the beam 202 described later has an inner circumferential shape (substrate inner surface 201a) obtained by hollowing out substantially the center in FIG. 2 into a cylindrical shape. The substrate peripheral portion 201 is sandwiched by the first substrate 205 and the third substrate 206 of FIG. 3 from the upper side and the lower side of FIG. 3. How to sandwich the substrate peripheral portion 201 is not particularly limited, but in this embodiment, the substrate peripheral portion 201 is sandwiched by the first substrate 205 and the third substrate 206 over the full width of the shaded region of the substrate peripheral portion 201 illustrated in FIG. 2.

The mass body 203 is formed into a ring shape (tubular shape) having a mass body inner surface 203a and a mass body outer surface 203b illustrated in FIG. 2, and is positioned inside the substrate inner surface 201a of the substrate peripheral portion 201 hollowed out into the cylindrical shape. In addition, the mass body 203 is not in contact with the first substrate 205 and the third substrate 206 illustrated in FIG. 3 but is positioned between the first substrate 205 and the third substrate 206 via air gaps.

The beam 202 connects the substrate peripheral portion 201 and the mass body 203 to each other. The beam 202 is elastic and is formed so as to substantially go around inside a gap between the substrate peripheral portion 201 and the mass body 203. Specifically, one end of the beam 202 is connected to the substrate peripheral portion 201 at the substrate inner surface 201a on the lower side of FIG. 2, and the other end of the beam 202 is connected to the mass body 203 at the mass body outer surface 203b on the lower side of FIG. 2. In addition, similarly to the mass body 203, the beam 202 is not in contact with the first substrate 205 and the third substrate 206 illustrated in FIG. 3 but is positioned between the first substrate 205 and the third substrate 206 via air gaps. Note that, the top surface of the beam 202 in FIG. 3 is flush with the top surface of the mass body 203, but the top surface of the beam 202 may be flush with a connection surface between the substrate peripheral portion 201 and the first substrate 205. The beam 202 in FIG. 3 is formed so that the vertical width is smaller than the vertical width of the mass body 203.

The counter electrode 204 has a cylindrical shape, and is positioned inside one mass body inner surface 203a and at substantially the center of the acceleration switch 002. The center of the counter electrode 204 substantially matches with the centers of the substrate peripheral portion 201 and the mass body 203. In addition, the counter electrode 204 is sandwiched by the first substrate 205 and the third substrate 206 of FIG. 3 from the upper side and the lower side of FIG. 3.

The through electrodes 207 and 208 in this embodiment have a tapered shape or a conical shape in the depth direction from the top surface of the first substrate 205 in FIG. 3. The through electrodes 207 and 208 are not in contact with each other, and are formed to pass through the first substrate 205 to the depths reaching the substrate peripheral portion 201 and the counter electrode 204 of FIG. 3, respectively. In order to reliably connect the through electrodes 207 and 208 to the substrate peripheral portion 201 and the counter electrode 204, concave portions 201b end 204b are formed in the substrate peripheral portion 201 and the counter electrode 204, respectively, so that the distal ends of the through electrodes 207 and 208 may enter the concave portions 201b and 204b. Note that, the purpose of the through electrodes is to establish electrical conduction of the substrate peripheral portion 201 and the counter electrode 204, respectively, and hence the shape is not limited as long as the through electrodes are in contact with the substrate peripheral portion 201 and the counter electrode 204, respectively.

In this case, the substrate peripheral portion 201 and the counter electrode 204 are sandwiched by the first substrate 205 and the third substrate 206 illustrated in FIG. 3, but the first substrate 205 and the third substrate 206 are formed of an insulating material as described above, and hence the substrate peripheral portion 201 and the counter electrode 204 are not electrically connected to each other.

Note that, in this embodiment, the surface at which the first substrate 205 and the substrate peripheral portion 201 are in contact with each other and the surface at which the first substrate 205 and the counter electrode 204 are in contact with each other are formed so as to protrude toward the substrate peripheral portion 201 side and the counter electrode 204 side, respectively. This is for the purpose of providing air gaps between the above-mentioned beam 202 and mass body 203 and the first substrate 205 with ease. Therefore, on the surface at which the third substrate 206 and the substrate peripheral portion 201 are in contact with each other and the surface at which the third substrate 206 and the counter electrode 204 are in contact with each other, the third substrate 206 may be formed so as to protrude toward the substrate peripheral portion 201 side and the counter electrode 204 side.

In this case, when acceleration is applied in the arrow direction as illustrated in FIG. 4, the overall acceleration switch 002 moves in the arrow direction, but the mass body 203 supported by the beam 202 does not move, and hence the counter electrode 204 provided in the space inside the mass body is brought into contact with the mass body 203. Note that, FIG. 4 omits the beam 202 and the substrate peripheral portion 201 around the mass body 203 for simple illustration. As a result, the electrical conduction is established from the counter electrode 204 via the mass body 203, the beam 202, the substrate peripheral portion 201, and the through electrode 207 to an external contact. The counter electrode 204 is also connected to an external contact via the other through electrode 208.

As a more specific embodiment, the gap between the counter electrode 204 and the mass body 203 is defined. The gap is determined so that, when vibration or gravity of a predetermined value or more is applied to the mass body 203 in this embodiment, the counter electrode 204 and the mass body 203 may be brought into contact with each other to activate the acceleration switch 002. The gap is determined so that the mass body 203 may be brought into contact with the counter electrode 204 when a load of, for example, 0.8 G to 1.2 G or more is applied to the acceleration switch 002. The predetermined value is an acceleration value when a human starts an action. Particularly in the case of employing a module such as an acceleration switch in an electronic device such as a pedometer, it is most suitable to consider the application of a load of 1 G or more for activating the acceleration switch.

The reason why the gap is defined so that the acceleration switch 002 is activated by a load of, for example, 0.8 G to 1.2 G or more is that microvibration typically called vibration noise is mainly a vibration of less than 0.8 G. Another reason is that, on the arm or the waist where the pedometer is mounted, vibration energy applied to the pedometer during counting of steps indicates a numerical value of about 0.8 G or more. In particular, the gravity applied to the waist at the start of walking is a load of more than 1.5 G. Therefore, by defining the gap, a desired timing of turning ON the acceleration switch can be set in accordance with the type of pedometer.

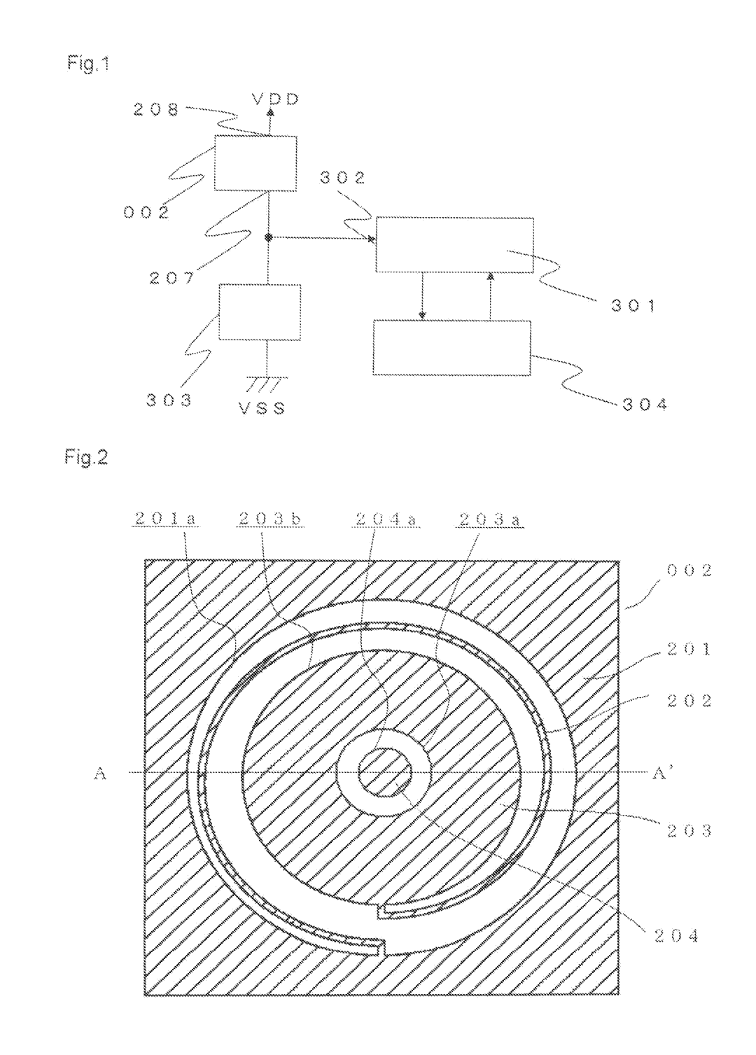

In this way, the acceleration switch is configured to be turned ON (the state where the electrical conductions via the through electrodes 207 and 208 are established) when the magnitude of vibration becomes a predetermined value or more and be turned OFF (the state where the electrical conductions via the through electrodes 207 and 208 are not established) when the magnitude of vibration becomes less than the predetermined value. The ON/OFF state of the contacts is input to the interrupt input terminal of the microcomputer or the sensor element, so as to activate the microcomputer or the sensor element. The details are described with reference to FIG. 1.

FIG. 1 is a circuit diagram for connecting the acceleration switch to the microcomputer. The acceleration switch 002 has two connection lines, one of which (through electrode 208) is connected to a positive power supply VDD (one power supply section; VDD is power supply voltage) while the other of which (through electrode 207) is connected to an interrupt input terminal 302 of a microcomputer 301. A load 303 is connected to the ground (the other power supply section; connected to a negative power supply VSS) via a line not connected to the acceleration switch 002 and the microcomputer 301. The interrupt input terminal 302 of the microcomputer 301 is grounded via the load 303. In other words, the line for connecting the acceleration switch 002 and the load 303 has a connection point in the middle connected to the microcomputer 301. The microcomputer 301 is further connected to a sensor main body 304. The sensor main body 304 is activated or stopped in response to a signal from the microcomputer 301 and, when activated, outputs acceleration information to the microcomputer 301. In other words, the sensor main body 304 can transmit and receive signals to and from the microcomputer 301 bi-directionally. In this case, the load 303 serves to determine the potential level of the interrupt input terminal 302 of the microcomputer 301 when the acceleration switch 002 is turned OFF. The load 303 is therefore formed of a resistor or a capacitor.

Note that, this circuit can also be completed without using the load 303. In this case, the acceleration switch is connected to the interrupt input terminal 302 of the microcomputer 301 similarly to the above, but, unlike the above-mentioned configuration, the load 303 is not provided on wiring of the circuit but the circuit is connected to only the one power supply section.

The load 303 may be formed by a combination of resistors or capacitors connected in series or parallel. In addition, the same function can be realized also with the use of an active element such as a transistor. For simple description, the load 303 is hereinafter referred to as a resistor 303. In FIG. 1, open/close information of the acceleration switch is input to the microcomputer 301 for activating the microcomputer 301, but the open/close information may be directly input to the sensor main body 304 so as to active the sensor main body 304. Also in this configuration, the present invention can be achieved.

Next, the operation is described. In the state where no vibration or acceleration is generated or the state where only a vibration of less than a predetermined value is applied, all functions of the microcomputer 301 are in the OFF state or only part of the functions is in the ON state, and hence almost no current is consumed. Because of the state where no vibration or acceleration is generated or the state where only a vibration of less than a predetermined value in applied, the contacts of the acceleration switch 002 are open. Accordingly, the acceleration switch 002 is not connected to the positive power supply VDD, and the input to the interrupt input terminal 302 is pulled down by the resistor 303 to be Low (negative power supply VSS).

Next, in the state where a vibration or an acceleration of a certain value or more is generated, the contacts of the acceleration switch 002 are closed, and the positive power supply VDD is input to the interrupt input terminal 302. In this case, a current flows via the resistor 303, but its current consumption is suppressed by increasing the resistance value of the resistor 303. A High signal input to the interrupt input terminal 302 activates the microcomputer 301. In other words, the microcomputer 301 is of a type in which the interrupt input terminal 302 thereof is interrupted at High level.

Note that, paying attention to suppressing current consumption, it is also possible to switch around the acceleration switch 002 and the load 303 illustrated in FIG. 1. Those forms can be selectively used for realizing a desired circuit configuration.

The activated microcomputer 301 transmits a signal for activating the sensor main body 304 to the sensor main body 304, and real-time vibration or acceleration is measured by the sensor main body 304. In other words, the acceleration switch 002 can be used for activating the sensor main body 304.

In view of this purpose, one end of the acceleration switch 002 may be connected directly to the sensor main body 304 so that the sensor main body 304 may be activated not via the microcomputer 301. This form can further improve the responsiveness of the sensor main body 304 with respect to vibration or acceleration. In general, the sensor main body 304 has a low current consumption mode. In the present invention, however, the sensor main body 304 can be completely stopped to reduce the current consumption to be completely zero. In this way, lower current consumption of the system can be realized, and the cattery life of the pedometer can be extended to about 5 years.

In the state where the generation of vibration or acceleration is stopped, no signal is transmitted from the sensor main body 304, and hence the microcomputer 301 can detect this state. In this state, it is unnecessary to operate the sensor main body 304, and hence the operation of the sensor main body 304 is stopped for reducing current consumption. After that, the microcomputer 301 becomes the state where all the functions are OFF or only part of the functions is ON, to thereby reduce the current consumption.

In this embodiment, the case where the interrupt input terminal 302 is interrupted at High level has been exemplified. Depending on the microcomputer, the interrupt input terminal 302 may be interrupted at Low level. In this case, the same effect can be obtained by reversing all connections and states as compared to this embodiment. For example, in the description of FIG. 1, the positive power supply (VDD) is replaced with the negative power supply (VSS), the pull-down is replaced with the pull-up, the pull-up is replaced with the pull-down, and High level is replaced with Low level.

Note that, the electric circuit to be used in the second acceleration switch illustrated in FIG. 1 described in this embodiment is versatile for use in the first acceleration switch illustrated in FIG. 5. Specifically, because the difference between the first acceleration switch and the second acceleration switch is that the number of beams is one or four, the through electrodes 207 and 208 as well as the electric circuit illustrated in FIG. 1 can be used without changing their configurations.

In addition, although not described in detail in the embodiment of the first acceleration switch, the first substrate 205 and the third substrate 206 can also be used without changing the form illustrated in FIG. 3 and the configurations described in the embodiment.

Further, this embodiment has paid attention to the acceleration sensor using the acceleration switch, but the application of the present invention is not limited to a mechanical element called acceleration sensor, and is applicable to every type of publicly-known mechanical element for sensing vibration or acceleration.

What is claimed is:

1. An acceleration signal processing device, comprising:
power supply sections having power supply voltages;
an acceleration switch including one electrode to be supplied with the power supply voltage from one of the power supply sections;
a microcomputer connected to another electrode of the acceleration switch; and
a sensor main body capable of bi-directionally exchanging signals to and from the microcomputer,
the sensor main body being configured to be one of activated and stopped in response to a signal from the microcomputer, and being configured to, when activated, output acceleration information to the microcomputer.

2. An acceleration signal processing device according to claim 1, further comprising a load element including one terminal connected between the acceleration switch and the microcomputer and another terminal connected to another of the power supply sections.

3. An acceleration signal processing device according to claim 2, wherein the load element comprises at least one of a resistor, a capacitor, and a transistor.

4. An acceleration signal processing device according to claim 3, wherein the acceleration switch comprises:
a mass body having a space inside;
a beam for supporting the mass body; and
a counter electrode positioned inside the space.

5. An acceleration signal processing device according to claim 2, wherein the acceleration switch comprises:
a mass body having a space inside;
a beam for supporting the mass body; and
a counter electrode positioned inside the space.

6. An acceleration signal processing device according to claim 1, wherein the acceleration switch comprises:
a mass body having a space inside;
a beam for supporting the mass body; and
a counter electrode positioned inside the space.

7. An acceleration signal processing device according to claim 6, wherein:
the acceleration switch is switched to ON when the mass body and the counter electrode are brought into contact with each other; and
a gap between the mass body and the counter electrode is set so that the mass body and the counter electrode are brought into contact with each other when vibration energy of a predetermined value or more is applied to the acceleration switch.

8. An acceleration signal processing device according to claim 7, wherein the predetermined value comprises an acceleration value when a human starts an action.
